(19) United States
(12) Patent Application Publication
(10) Pub. No.: US 2023/0003634 A1
(43) Pub. Date: Jan. 5, 2023

(54) LOW-POWER SENSOR NETWORK

(71) Applicant: University of Alaska Anchorage, Anchorage, AK (US)

(72) Inventors: Matthew Cullin, Anchorage, AK (US); Todd Peterson, Anchorage, AK (US); Raghu Srinivasan, Anchorage, AK (US)

(73) Assignee: University of Alaska Anchorage, Anchorage, AK (US)

(21) Appl. No.: 17/782,042

(22) PCT Filed: Dec. 4, 2020
(86) PCT No.: PCT/US2020/063364

§ 371 Date: Jun. 2, 2022

Related U.S. Application Data
(60) Provisional application No. 62/943,617, filed on Dec. 4, 2019.

(51) Int. Cl. G01N 17/04

(52) U.S. Cl. CPC G01N 17/043

(57) ABSTRACT

Methods and systems for low-power wireless sensor networks of conductivity probes for the detection of corrosive fluids inside pressure vessels and piping are described. Conductivity probes that can be easily integrated into existing internal corrosion monitoring infrastructure (access fittings) and connected via a low-power wireless sensor network are described herein.

### CROSS-REFERENCE TO RELATED APPLICATION

This application claims the benefit of U.S. Provisional Application No. 62/943,617, filed on Dec. 4, 2019, the entirety of which is hereby incorporated by reference herein.

### BACKGROUND

In the upstream oil and gas environment, internal corrosion presents a significant threat to metallic piping and tanks. The average annual cost of corrosion in the U.S. transmission pipeline sector (including natural gas and crude oil gathering lines) is estimated to be $7B per year. Corrosion coupons (CCs) and electrical resistance (ER) probes are often installed at access fittings which permit the removal and reinstallation of the coupons/probe while the system is operating (e.g., at operational pressures). The primary limitation of CCs and ER probes in remote locations is the lack of complete system coverage. It is often impractical to install either monitoring method at intermediate points between facilities. When operating in onshore, arctic locations, pipelines are largely aboveground, however, they are also insulated. While their aboveground location provides an opportunity for additional monitoring points, the presence of insulation and the inaccessibility of many locations during certain seasons presents additional challenges. In-line inspection (ILI) techniques provide “complete” system inspection, but have a relatively low sensitivity (compared to other monitoring techniques) and are prone to noise. As a result of these limitations, the exposure period required to accrue corrosion damage that is detectable via ILI tools is significantly longer (2-5 years). Discrete non-destructive inspection (NDI) locations are also employed, but are limited by accessibility and the operational limits of the inspector and the equipment. A primary drawback of using electronic sensors for continuous corrosion monitoring in remote locations is the need to provide power at the test location. Another primary drawback of using electronic sensors for continuous corrosion monitoring in remote locations is the need to provide communications at the test location. Given the aforementioned limitations of current monitoring techniques, the development of a standalone, remotely-monitored corrosion sensor, capable of operating for long periods without service, would be extremely advantageous. Such a device would assist operators in extending the coverage of their corrosion monitoring system, allowing sensors to be installed at known problem locations (e.g., dead legs, low spots, etc.) where the deployment of CCs and ER probes is not practical. Conductivity sensors are simple, robust, and relatively low-power instruments. In some process streams, the measurements from strategically-oriented conductivity probes may correlate well with corrosion rates, or at the very least, can be used to detect the presence of an electrolyte (indicating a likelihood of corrosion). These and other considerations are addressed herein.

### SUMMARY

It is to be understood that both the following general description and the following detailed description are exemplary and explanatory only and are not restrictive. Methods and systems for detecting corrosive fluids are described herein. A probe comprising one or more sensors may be disposed in a vessel (e.g., a pipe or other container) such that the one or more sensors are exposed to a process fluid. The probe may be a low-power, standalone probe. The one or more sensors may comprise an electrochemical sensor. The electrochemical sensor may generated a signal. The signal may be received by an analysis unit. The signal may relate to a condition such as the presence of an analyte in a corrosive fluid. A determination may be made as to whether the condition satisfies a threshold. The threshold may comprise a value. If it determined the condition satisfies the threshold, an alarm may be generated. This summary is not intended to identify critical or essential features of the disclosure, but merely to summarize certain features and variations thereof. Other details and features may be described in the sections that follow.

### BRIEF DESCRIPTION OF THE DRAWINGS

The accompanying drawings, which are incorporated in and constitute a part of the present description serve to explain the principles of the methods and systems described herein:

FIG. 1 shows an example apparatus;

FIG. 2 shows an example system;

FIG. 3 shows an example conductivity probe;

FIG. 4 shows an example conductivity probe;

FIG. 5 shows an example test bed;

FIG. 6 shows an example method; and

FIG. 7 shows a block diagram of an example computing environment.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it may be understood that the particular value forms another configuration. It may be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As may be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It may be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It may also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action. Described herein are methods and systems for detecting corrosion.

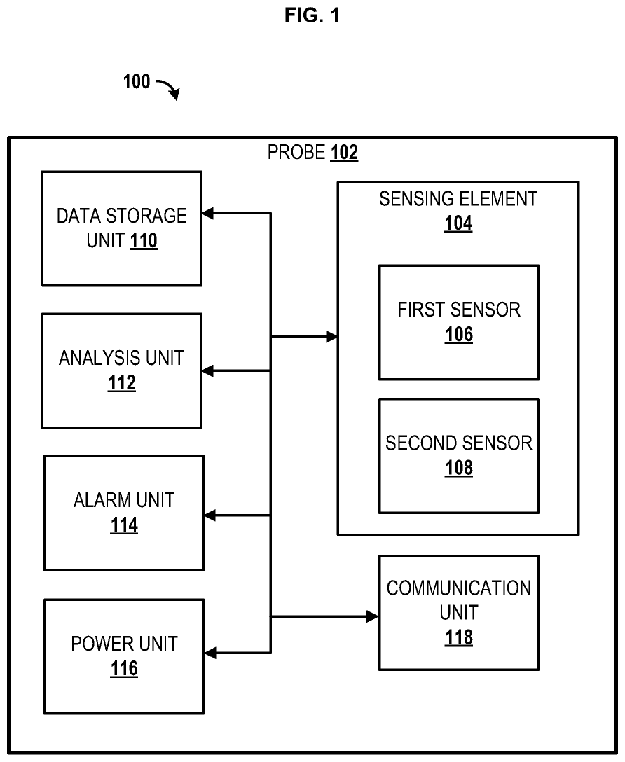

Turning now to FIG. 1, an example apparatus 100 is shown. The apparatus 100 may comprise one or more probes 102. The one or more probes 102 may comprise a remotely-monitored corrosion sensor. For example, the one or more probes 102 may comprise a power unit 116. The power unit 116 may comprise, for example, a standalone power source such a battery, a solar cell, a wind power generation technique, or any other distributed energy resource (DER) not requiring a connection to a power grid. The one or more probes 102 may comprise a power subsystem. For example, the power subsystem may store energy from the power unit 116. For example, the power subsystem may comprise a super-capacitor. For example, if the power unit 116 is a solar cell or other photovoltaic (PV) cell or other energy harvesting device, the super-capacitor (or any other suitable energy storage device) may accumulate a charge. The charge may be sufficient for powering the one or more probes 102.

The one or more probes 102 may comprise a sensing element 104. The sensing element 104 may comprise a first sensor 106 and a second sensor 108. The first sensor 106 may comprise an electrochemical sensor. For example, the first sensor 106 may comprise one or more electrodes. As an example, the first sensor 106 may comprise at least one anode and at least one cathode. The at least one anode may comprise at least one conducting material. For example, the at least one conducting material may comprise at least one of magnesium, aluminum, zinc, lithium, or similar materials and the like and combinations thereof. The at least one cathode may comprise at least one conducting material. For example, the at least one cathode may comprise cobalt, nickel, manganese and the like and combinations thereof. The at least one cathode and the at least one anode may be electronically coupled such that an electronic signal passes between them. The sensor may comprise an electrochemical sensor. The electrochemical sensor may comprise a working and counter electrode combination which are configured to produce an electrical signal that is related to the concentration of an analyte in the process fluid. The electrode pair (working and counter) may be configured to produce an electrical signal which is sufficiently strong to provide a signal-to-noise ratio suitable to distinguish between concentration levels of the analyte over an entire range of interest. In other words, the current flow between the working electrode and the counter electrode may be measurably proportional to the concentration of the analyte over the concentration range of interest. In addition to a working electrode and a counter electrode, the electrochemical sensor may include a third, reference electrode. The reference electrode may be configured to maintain the working electrode at a known voltage or potential. The reference electrode may be physically and chemically stable in the electrolyte and carry the lowest possible current to maintain a constant potential. The ER probe may consist of a resistive element made from the vessel material. As corrosion thins the resistive element, the measured electrical resistance increases. This change in resistance may be translated into a corrosion rate. ER probes are the most sensitive of the aforementioned methods and provide the shortest response time, typically between 1 and 10 days.

The process fluid may be multiphase mixtures (oil, water, and natural gas), water (for secondary recovery), produced water, separated oil (with residual water), wet natural gas, and dry natural gas. Other gasses, such as oxygen, carbon dioxide, and hydrogen sulfide may also be present in production fluids and can greatly impact internal corrosion rates and mechanisms.

The first sensor 106 (e.g., the electrochemical sensor) may draw power generated by the power source and stored by the power subsystem. For example, once sufficient charge has been accumulated, the sensor wakes up, acquires a new data point from the attached sensor, queries the network for communication protocols, and exchanges stored data with the network. If sufficient charge remains on the super-capacitor, there is a built in delay before the cycle repeats. If there is insufficient charge, the device sleeps until the energy harvesting circuity has replenished the requisite charge.

In an embodiment, the one or more probes 102, may comprise one or more antifouling electrodes. For example, the one or more probes 102 may comprise one or more of anode and cathode elongate antifouling electrodes, each comprising an uninsulated, distal, terminal tip, between which an electrical current flows, wherein the sensing electrodes and antifouling electrode tips are disposed on a planar surface, which may be flat or curved, and the antifouling electrode tips, when disposed in a process fluid the current causes chemical reactions in the process fluid around one or both of the sensor electrodes tips which reduces or prevents fouling of the tip of one or both of the sensor electrodes.

The sensing element 104 may comprise a second sensor 108. The second sensor 108 may comprise one or more corrosion coupons. The one or more corrosion coupons may comprise a material susceptible to corrosion. The one or more corrosion coupons (CCs) may be disposed in or on one or more corrosion coupon holders. The CCs may be configured so as to not require electrical power. The CCs may be disposed in the process fluid so as to contact the process fluid over a period of time. The CCs may be composed of a metal which corrodes at a particular rate when exposed to electrolytes. For example, the CCs may have an initial weight and a corroded weight. The initial weight may be the weight (e.g., mass) of the coupon before the coupon has been exposed to the process fluid. For the corroded weight (e.g., corroded mass) may be the weight of the coupon after the coupon has been exposed to the process fluid for an exposure period. The exposure period may be 60, 90, 120 days, or the like. The CCs may comprise a material similar to the material of the vessel which carries the process fluids. The CCs may be comprised of a material which, when exposed to a process fluid, may suffer corrosion and thus the mass of the corrosion coupon may change over time. As such, the mass lost during the exposure period is used to calculate the average corrosion rate of the coupon material during that time. This value is ostensibly correlated to the average corrosion rate experienced by the vessel material.

The one or more probes 102 may be situated in an access fitting. The one or more probes 102 may remain in the access fitting for a period of time. For example, the one or more probes 102 may remain in the access fitting for a period of 1-6 months.

The one or more probes 102 may comprise a data storage unit 110. The data storage unit 110 may comprise a system memory 712 as further described herein. The data storage unit 110 may comprise computer readable media in the form of volatile memory, such as random access memory (RAM), and/or non-volatile memory, such as read only memory (ROM). The data storage unit 110 may store corrosion data among other data.

The one or more probes 102 may comprise an analysis unit 112. The analysis unit 112 may be configured to receive signals from the sensing element 104. The analysis unit 112 may be configured to analyze received data or signals or the like or combinations thereof. The analysis unit 112 may be configured to detect a condition. For example, the condition may comprise the presence or absence of a corrosive fluid. The condition may comprise the presence or absence of an electrolyte, for example salt, potassium, magnesium, and the like and combinations thereof. The condition may comprise the presence or absence of an analyte.

The one or more probes 102 may comprise an alarm unit 114. The alarm unit 114 may be communicatively coupled to the analysis unit 112, for example. The alarm unit 114 may be configured to output an alarm. The one or more probes 102 may comprise a power unit 116. The power unit 116 may comprise a battery, a solar cell, a photovoltaic cell, a piezoelectric generator, a geothermal or thermochemical power unit, a wind turbine and the like and combinations thereof. The power element 116 may be communicatively coupled to the sensing element 104, the data storage unit 110, the analysis 112, the alarm unit 114, and/or a communication element 118. The power element may generate an electric current or voltage. The power unit may facilitate the transmission of an electric current. The current may be alternating or direct. The power unit may facilitate the transmission of a voltage.

The one or more probes 102 may comprise a communication element 118. The communication element 118 may comprise a radio or a transceiver or the like. The communication element 118 may be configured to transmit or receive signals by any reasonable means including, but not limited to, by way of Bluetooth, low-energy Bluetooth, Wi-Fi, cellular network, 3G, 5G, radio-frequency, infrared, and the like and combinations thereof. The communication element 118 may be configured to allow the one or more probes 102 to communicate with each other as well as with the computing device 208 and the user device 202.

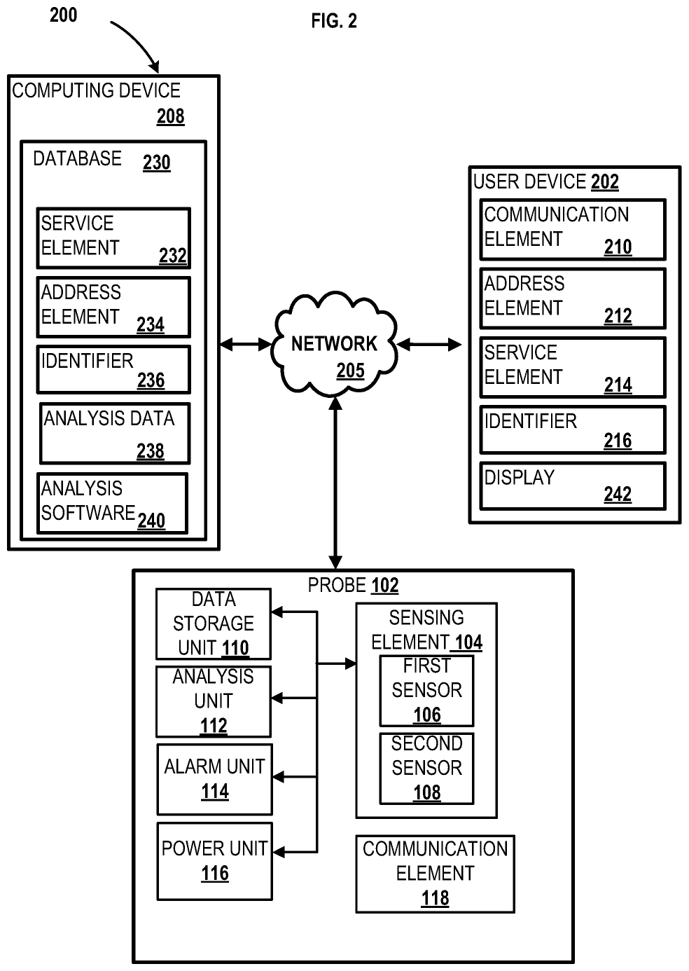

Turning now to FIG. 2, an exemplary system 200 is shown. The system 200 may comprise a distributed wireless sensor network (WSN). The system 200 may comprise a computing device 208. The computing device 208 may comprise a computer, a smartphone, a laptop, a tablet, a server, a gateway, a network device, router, access point, premises equipment and the like or any other similar device. The computing device 208 may comprise a database 230. The database may comprise a service element 232. The computing device 208 may comprise an address element 234. The address element may comprise an internet protocol address, a network address, a MAC address, a location identifier, or the like. The computing device 208 may comprise an identifier 236. The identifier 236 may comprise an internet protocol address, a network address, a MAC address, a location identifier, or the like. The database may store analysis data 238. The analysis data 238 may comprise measurements, readings, calculations, estimations and the like and combinations thereof. For example, the analysis data 238 may be electrochemical corrosion measurements, such as Linear Polarization Resistance (LPR), Electrical Impedance Spectroscopy (EIS), and Zero Resistance Ammetry (ZRA), fluid conductivity measurements, for example associated with total dissolved solids (TDS). For example, the electrical conductivity of the process fluid may be measured by determining the resistance of the process fluid between the two electrodes which are separated by a fixed distance. For example, an alternating voltage may be used in order to avoid electrolysis. The resistance may be determined by a conductivity meter. The voltage may have a frequency in the range of 1-3 kHz, however it is to be understood that any suitable frequency may be used.

The database 230 may store a plurality of files, records, identifiers or data and the like and combinations thereof. The database may further comprise analysis software 240. The analysis software may be configured to execute an analysis program. For example, the analysis software may be configured to receive inputs such as LPR, EIS, ZRA, or TDS, and determine whether the inputs satisfy a condition. The condition may be related to a threshold. For example,

The computing device 208 may be communicatively coupled to the one or more probes 102. The computing device 208 may be communicatively coupled to the one or more probes 102 through a network 205. The network 205 may comprise a premises network, a local area network (LAN), wide-area network, or any other wired or wireless telecommunications channel, for example.

The system 200 may further comprise a user device 202. The user device 202 may be communicatively coupled to the computer device and/or the sensor device. The user device 202 may be communicatively coupled to the computing device 208 and/or the one or more probes 102 through network 205. The user device 202 may comprise a computer, a smartphone, a laptop, a tablet and the like, for example. The user device 202 may comprise a communication element 210. The communication element 210 may comprise a radio or a transceiver or the like. The communication element 210 may be configured to transmit or receive signals by any reasonable means including, but not limited to, by way of Bluetooth, low-energy Bluetooth, Wi-Fi, cellular network, 3G, 5G, radio-frequency, infrared, and the like and combinations thereof. The user device 202 may comprise an address element 212. The user device 202 may comprise a service element 214. The address element 214 may comprise an internet protocol address, a network address, a MAC address, a location identifier, or the like. The user device 202 may comprise an identifier 226. The identifier 226 may comprise an internet protocol address, a network address, a MAC address, a location identifier, or the like. The user device 202 may comprise a display 242.

The system 200 may comprise a distributed wireless sensor network (WSN). The

WSN may comprise the one or more probes 102 distributed over an area. For example, the WSN may comprise twelve probes distributed equidistant from each other over an area of 5000 m^{s}. The aforementioned example is merely exemplary and explanatory and is not meant to be limiting. The one or more probes may be positioned such that they may communicate with each other wirelessly, for example through 3G, 5G, wifi, Bluetooth, Zigbee, or any other suitable communication protocol. For example, if a first probe of the one or more probes 102 detects a condition satisfying a threshold, the first probe may relay that information to a second probe of the one or more probes 102. This process may be repeated until, with the signal passing from one probe to another until the signal reaches a probe within a transmission distance of the computing device at which point the signal may be passed to the computing device. For example, operating at low power, the maximum transmission distance of the communicate unit 118 may be 100 meters. As such, along a pipeline, the one or more probes may be located at 100 m intervals so as to facilitate communication among the one or more probes 102. Similarly, in a grid area (as opposed to a linear arrangement along a pipeline), the one or more probes may be arranged geometrically such that any given probe of the one or more probes 102 is within transmission distance of at least one other probe of the one or more probes 102. As such, as long as a transmission path exists between any two probes of the one or more probes 102, data for the entire WSN can be collected by communicating with one probe.

Communication between the one or more probes 102 may occur regularly (e.g., on a schedule) or sporadically. For example, sporadic communication may occur if the power unit 116 of a given probe of the one or more probe 102 is exposed to sunlight to provide a sufficient charge for communication, at which point, the given probe may communicate with another probe.

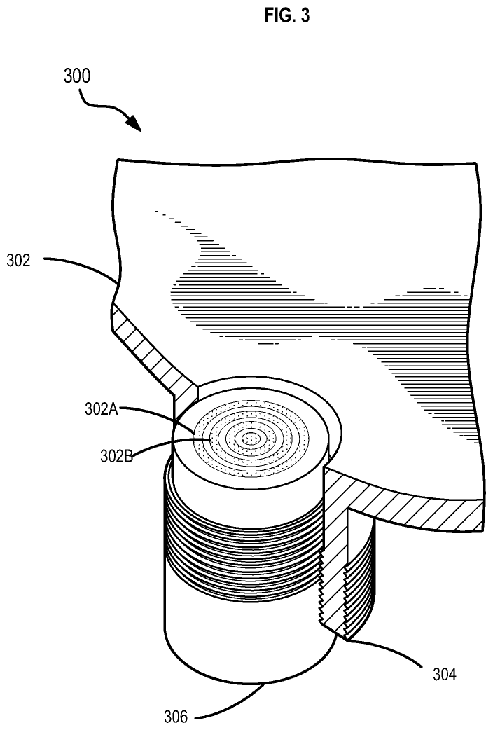

Turning now to FIG. 3, an example probe 300 is shown. The probe 300 may be the one or more probes 102. The probe 300 may comprise one or more sensors. The probe 300 may be disposed in a pipe or other vessel configured to transport or otherwise contain the process fluid. The probe may be disposed on the inner wall of a pipe or vessel. Further, the probe 300 may be disposed in an access fitting situated in the wall of a pipe or vessel. The probe 300 may comprise conductivity sensor electrodes. The probe 300 may comprise electrical terminals for conductivity sensor electrodes. 300 The probe may be secured to the wall of the pipe or vessel by way of screw-threading, nails, fasteners, joining materials such as glue, or any other reasonable means or combinations thereof. The probe 300 may comprise a sensor. The probe 300 may comprise a standalone conductivity probe. The senor may comprise one or more conductivity sensor electrodes 302A, 302B. While the one or more conductivity sensor electrodes 302A and 302B are shows as substantially cylindrical, it is to be understood the one or more conductivity sensor electrodes may be any shape, size, or form. The one or more conductivity sensor electrodes 302A and 302B may comprise one or more exposed elements. The one or more exposed elements may be conductors (metals) and they require little in the way of maintenance and re-calibration. The robust nature of conductivity probes makes them well-suited for remote locations with limited accessibility. Conductivity measurements consume a relatively small amount of electrical energy. As such, they are an ideal technique for applications where electrical utilities are not present, or, where a local energy harvesting device (e.g., thermoelectric, solar, etc.) is to be used. For locations with limited communications infrastructure, conductivity probes are well-suited for integration into a low-power, wireless sensor network (WSN).

The probe 300 may be coupled to an access fitting 304. The probe 300 may be installed in the access fitting, for example at the 6 o'clock position of a pipe 306 or other container. The access fitting may comprise a first access fitting member couple to a second access fitting member. The first access fitting member and the second access fitting member may be together in substantially sealed connection to create a seal therebetween. For example, the first access fitting member may be disposed on the probe 300 while the second access fitting member is disposed on the interior of the pipe carrying the process fluid. For example, the first access fitting member may be coupled to the second access fitting member. The access fitting members may be fabricated from a corrosion resistant metal such as austenitic stainless steel. A number of other metals, including titanium and tantalum, are also suitable for use in the present invention. The probe 300 may be electrically coupled to the power unit via one or more electrical terminals 306.

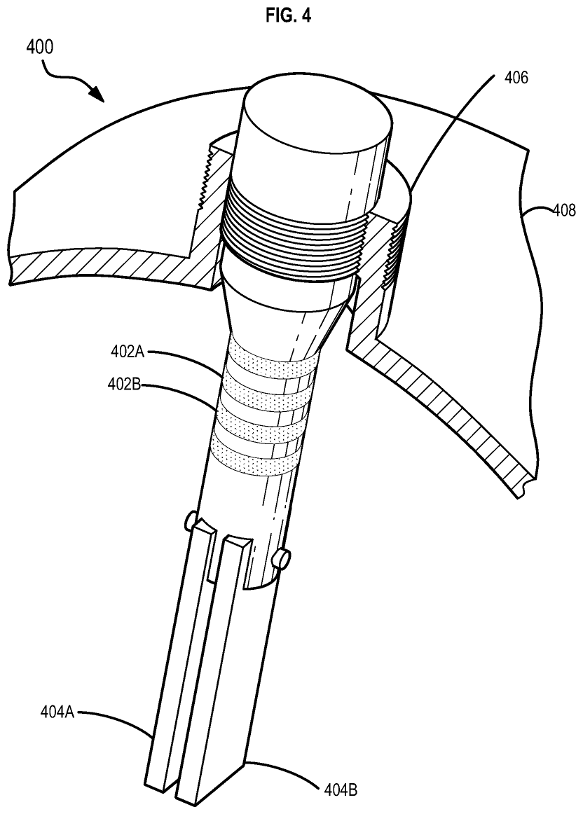

Turning now to FIG. 4, an example probe 400 is shown. The probe 400 may be the one or more probes 102 and/or the probe 300. The probe 400 may comprise one or more conductivity sensor electrodes 402A and 402B. The one or more conductivity sensor electrodes may comprise one or more electrodes. For example, the one or more conductivity sensor electrodes may comprise, in various configurations two or more electrodes 402A and 402B. While FIG. 4 shows two electrodes, it is to be understood that any appropriate number and configuration of electrodes may be used. For example, the probe 400 may be configured for measuring the conductivity of electrolytes via the four-point method as is known in the art. This technique requires four, electrically-isolated conductors to be submerged in a fluid of interest. A known current is passed between the external conductors and the resulting voltage difference between the internal conductors is measured. In applications where the accuracy of the conductivity measurement is superseded by time-based trends (changes in conductivity), a more rudimentary two-point conductivity probe may be sufficient. In either the two- or four-point case, there must be a continuous electrolytic path between the electrodes. The accuracy of conductivity probes may be adversely affected by the accrual of solids on the electrode surfaces (fouling), however this electrode fouling error is expected to be less pronounced in conductivity measurements than in electrochemical corrosion rate measurements (e.g., LPR, EIS). The design of the probe 400 and the supporting electronics dictates the range of conductivity values that can be measured by the system. In multiphase process streams where a significant difference in conductivity exists between the phases, the orientation and flow regime about the probe's electrodes may influence the resulting measurements.

The probe 400 may comprise a conductivity probe integrated into corrosion coupon (CC) holder. The probe may be installed in the access fitting. The probe 400 may be disposed in a pipe or other vessel. The probe 400 may be disposed on the inner wall of a pipe or vessel. Further, the probe 400 may be disposed in an access fitting situated in the wall of a pipe or vessel. The probe may comprise conductivity sensor electrodes. The probe 400 may comprise electrical terminals for conductivity sensor electrodes. The probe may be secured to the wall of the pipe or vessel by way of screw-threading, nails, fasteners, joining materials such as glue, or any other reasonable means or combinations thereof.

The probe 400 may further comprise one or more corrosion coupons (CCs) 404A and 404B. The one or more corrosion coupons 404A and 404B may be disposed in or on one or more corrosion coupon holders. The CCs 404A and 404B may be configured so as to not require electrical power. The CCs 404A and 404B may be disposed in the process fluid so as to contact the process fluid over a period of time. The CCs 404A and 404B may be composed of a metal which corrodes at a particular rate when exposed to electrolytes. For example, the CCs 404A and 404B may have an initial weight and a corroded weight. The initial weight may be the weight (e.g., mass) of the coupon before the coupon has been exposed to the process fluid. For the corroded weight (e.g., corroded mass) may be the weight of the coupon after the coupon has been exposed to the process fluid for an exposure period. The exposure period may be 60, 90, 120 days, or the like.

The probe 400 may be disposed in an access fitting 406. The access fitting 406 may be disposed in a pipe or other container 408 suitable for transporting or otherwise containing the process fluid. The access fitting 406 may comprise a screw-type fitting wherein one part (e.g., a proximal end) of the probe is threaded so as to be coupled to a pipe 408 or any other suitable container configured for transporting or otherwise containing the process fluid and another (distal) end of the probe is exposed to the process fluid.

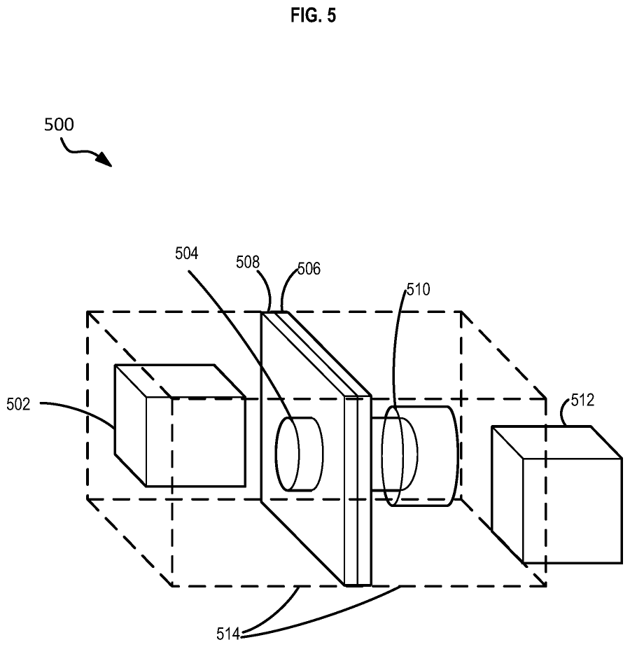

Turning now to FIG. 5, an example bed node 500 is shown. The bed node may comprise a mote. The bed node may comprise a wireless sensor node 502. The wireless sensor node 502 may comprise a power subsystem and an electronics subsystem. The power subsystem may comprise a power source. The power source may comprise, for example, a standalone power source such a battery, a solar cell, a wind power generation technique, or any other distributed energy resource (DER) not requiring a connection to a power grid. For example, the power subsystem may store energy from the power source. For example, the power subsystem may comprise a super-capacitor. For example, if the power source is a solar cell or other photovoltaic (PV) cell or other energy harvesting device, the super-capacitor (or any other suitable energy storage device) may accumulate a charge. The charge may be sufficient for powering the one or more probes 102. The power subsystem may be the power unit 116. The power unit 116 may comprise a battery, a solar cell, a photovoltaic cell, a piezoelectric generator, a geothermal or thermochemical power unit, a wind turbine and the like and combinations thereof. The power element 116 may be communicatively coupled to the sensing element 104, the data storage unit 110, the analysis 112, the alarm unit 114, and/or the communication element 118. The power element may generate an electric current or voltage. The power unit may facilitate the transmission of an electric current. The current may be alternating or direct. The power unit may facilitate the transmission of a voltage. The electronics subsystem may be the system 200 of FIG. 2. The electronics subsystem may comprise the analysis unit 112. The analysis unit may determine and/or receive the analysis data 238. The analysis data 238 may comprise measurements, readings, calculations, estimations and the like and combinations thereof. For example, the analysis data 238 may be electrochemical corrosion measurements, such as Linear Polarization Resistance (LPR), Electrical Impedance Spectroscopy (EIS), and Zero Resistance Ammetry (ZRA), fluid conductivity measurements, for example associated with total dissolved solids (TDS). For example, the electrical conductivity of the process fluid may be measured by determining the resistance of the process fluid between the two electrodes which are separated by a fixed distance. For example, an alternating voltage may be used in order to avoid electrolysis. The resistance may be determined by a conductivity meter. The voltage may have a frequency in the range of 1-3 kHz, however it is to be understood that any suitable frequency may be used.

The database 230 may store a plurality of files, records, identifiers or data and the like and combinations thereof. The database may further comprise analysis software 240. The analysis software may be configured to execute an analysis program. For example, the analysis software may be configured to receive inputs such as LPR, EIS, ZRA, or TDS, and determine whether the inputs satisfy a condition. The condition may be related to a threshold. For example,

The computing device 208 may be communicatively coupled to the one or more probes 102. The computing device 208 may be communicatively coupled to the one or more probes 102 through a network 205. The network 205 may comprise a premises network, a local area network (LAN), wide-area network, or any other wired or wireless telecommunications channel, for example.

The system 200 may further comprise a user device 202. The user device may be communicatively coupled to the computer device and/or the sensor device. The user device may 202 may be communicatively coupled to the computing device 208 and/or the one or more probes 102 through network 205. The user device 202 may comprise a computer, a smartphone, a laptop, a tablet and the like, for example. The user device may comprise a communication element 210. The communication element 210 may comprise a radio or a transceiver or the like. The communication element 210 may be configured to transmit or receive signals by any reasonable means including, but not limited to, by way of Bluetooth, low-energy Bluetooth, Wi-Fi, cellular network, 3G, 5G, radio-frequency, infrared, and the like and combinations thereof. The user device may comprise an address element 212. The user device may comprise a service element 214. The address element 214 may comprise an internet protocol address, a network address, a MAC address, a location identifier, or the like. The user device may comprise an identifier 226. The identifier 226 may comprise an internet protocol address, a network address, a MAC address, a location identifier, or the like. The user device may comprise a display 242.

The bed node 500 may further comprise the conductivity probe 504. The conductivity probe 504 may be integrated into the corrosion coupon (CC) holder. The conductivity probe 504 may be installed in the access fitting. The conductivity probe 504 may be disposed in a pipe or other vessel. The probe may be disposed on the inner wall of a pipe or vessel. Further, the probe may be disposed in an access fitting situated in the wall of a pipe or vessel. The probe may comprise conductivity sensor electrodes. The probe may comprise electrical terminals for conductivity sensor electrodes. The probe may be secured to the wall of the pipe or vessel by way of screw-threading, nails, fasteners, joining materials such as glue, or any other reasonable means or combinations thereof.

The bed node 500 may comprise a power system. The power system may comprise a power element. The bed node 500 may comprise a plate. The plate may be made of any suitable material, for example steel. The bed node may comprise a resistance heater element. The resistance heater element may be made from any suitable resistive material. The bed node 500 may comprise thermal insulation. The thermal insulation may comprise any suitable material. The bed node may comprise a probe. The probe may comprise a sensor. The bed node 500 may comprise an electrolyte reservoir. The electrolyte reservoir may be sealed. The bed node may comprise a temperature controller.

The bed node 500 may comprise a resistance heater element 508 disposed near a plate (e.g., a steel plate 506). The bed node 500 may comprise an electrolyte reservoir 510. The electrolyte reservoir may be configured to contain the process fluid so as to expose the sensor to the process fluid. The bed node 500 may comprise a temperature controller and power supply 512. The temperature controller and power supply unit 512 may be configured to control the temperature and power supply for the resistance heater element 508. The bed node 500 may be disposed within thermal insulation 514. The thermal insulation 514 may serve to maintain the temperature of the bed node 500.

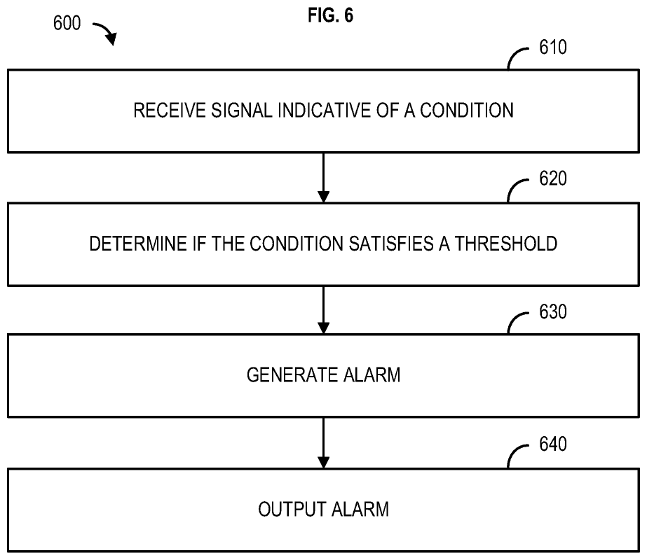

Turning now to FIG. 6, an example method 600 is shown. The method 600 may be carried out by any of the components described herein. For example the method 600 may be carried out by any of the computing device 208, the user device 202 the one or more probes 102, combinations thereof, and the like.

At step 610, a signal may be received. For example, the signal may comprise an electronic signal. The electronic signal may be generated by the one or more probes 102. For example, one or more of the one or more probes 102 may comprise an electrochemical sensor. The electrochemical sensor may be configured to detect the presence or absence and/or a level of an analyte in the process fluid. The electrochemical sensor may send a signal to the analysis unit 112. The analysis unit 112 may determine that the signal is associated with a condition. The condition may be the presence of absence and/or the level of the analyte in the process fluid. The signal may comprise an electromagnetic signal. The signal may be associated with a condition. For example, the signal may indicate a presence, absence, or degree of the condition. The condition may be a level of electrolytes disposed in a fluid, an indication of corrosion, a combination thereof, and/or the like.

At step 620, it may be determined whether or not the condition satisfies a threshold. For example, the threshold may be a value, such as a value indicative of the level of electrolytes disposed in the fluid, an amount (e.g., percentage, etc.) of the corrosion, a combination thereof, and/or the like. If it is determined the condition satisfies the threshold, an alarm may be generated (e.g., triggered) at step 630. The alarm may be an audible alarm, a message, a combination thereof, and/or the like. For example, the alarm may be a visual alarm.

The alarm may be outputted on an output device at step 640. The output device may be, for example, the alarm unit 114. The alarm unit 114 may be coupled to the communication element 118. For example, the alarm unit 114 may send an alarm to the communication element 118. The communication element 118 may be communicatively coupled to another device such as another of the one or more probes 102, the computing device 208, and/or the user device 202. The communication element 118 may send the alarm to any of the aforementioned devices.

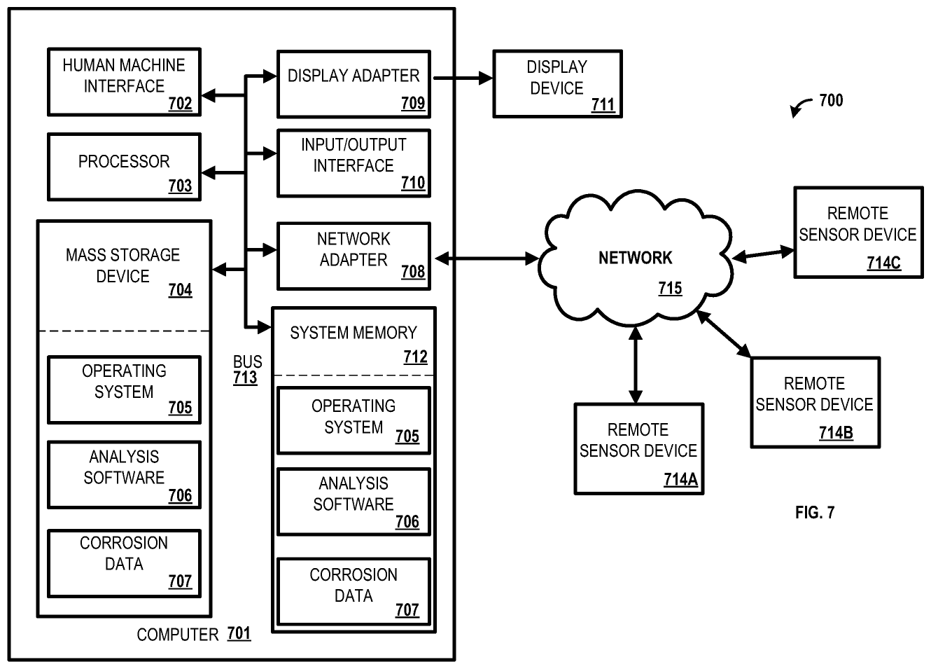

FIG. 7 shows a system 700 for detecting corrosive fluids in accordance with the present description. The one or more probes 102, the power device 344, the user device 302, the and/or the computing device 308 of FIG. 3 may each be a computer 701 as shown in FIG. 7. The computer 701 may comprise one or more processors 703, a system memory 712, and a bus 713 that couples various system components including the one or more processors 703 to the system memory 712. In the case of multiple processors 703, the computer 701 may utilize parallel computing. The bus 713 is one or more of several possible types of bus structures, including a memory bus or memory controller, a peripheral bus, an accelerated graphics port, or local bus using any of a variety of bus architectures.

The computer 701 may operate on and/or comprise a variety of computer readable media (e.g., non-transitory media). The readable media may be any available media that is accessible by the computer 701 and may include both volatile and non-volatile media, removable and non-removable media. The system memory 712 has computer readable media in the form of volatile memory, such as random access memory (RAM), and/or non-volatile memory, such as read only memory (ROM). The system memory 712 may store data such as corrosion data 707 and/or program modules such as the operating system 705 and analysis software 706 that are accessible to and/or are operated on by the one or more processors 703. The corrosion data 707 may include, for example, one or more hardware parameters and/or usage parameters as described herein. The analysis software 706 may be used by the computer 701 to cause one or more components of the computer 701 (not shown) to perform an analysis as described herein.

The computer 701 may also have other removable/non-removable, volatile/non-volatile computer storage media. FIG. 7 shows the mass storage device 704 which may provide non-volatile storage of computer code, computer readable instructions, data structures, program modules, and other data for the computer 701. The mass storage device 704 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 704, such as the operating system 705 and the analysis software 706. Each of the operating system 705 and the analysis software 706 (e.g., or some combination thereof) may have elements of the program modules and the analysis software 706. The corrosion data 707 may also be stored on the mass storage device 704. The corrosion data 707 may be stored in any of one or more databases known in the art. Such databases may be DB2®, Microsoft® Access, Microsoft® SQL Server, Oracle®, mySQL, PostgreSQL, and the like. The databases may be centralized or distributed across locations within the network 715.

A user may enter commands and information into the computer 701 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 703 via a human machine interface 702 that is coupled to the bus 713, but may be connected by other interface and bus structures, such as a parallel port, game port, an IEEE 1394 Port (also known as a Firewire port), a serial port, network adapter 717, and/or a universal serial bus (USB).

The display device 711 may also be connected to the bus 713 via an interface, such as the display adapter 707. It is contemplated that the computer 701 may have more than one display adapter 707 and the computer 701 may have more than one display device 711. The display device 711 may be a monitor, an LCD (Liquid Crystal Display), light emitting diode (LED) display, television, smart lens, smart glass, and/or a projector. In addition to the display device 711, other output peripheral devices may be components such as speakers (not shown) and a printer (not shown) which may be connected to the computer 701 via the Input/Output Interface 710. Any step and/or result of the methods may be output (or caused to be output) in any form to an output device. Such output may be any form of visual representation, including, but not limited to, textual, graphical, animation, audio, tactile, and the like. The display device 711 and computer 701 may be part of one device, or separate devices.

The computer 701 may operate in a networked environment using logical connections to one or more remote sensor devices 714A,B,C. A remote sensor device may be the one or more probes 102, a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 701 and a remote sensor device 714A,B,C may be made via a network 715, such as a local area network (LAN) and/or a general wide area network (WAN). Such network connections may be through the network adapter 717. The network adapter 717 may be implemented in both wired and wireless environments. Such networking environments are conventional and commonplace in dwellings, offices, enterprise-wide computer networks, intranets, and the Internet.

Application programs and other executable program components such as the operating system 705 are shown herein as discrete blocks, although it is recognized that such programs and components reside at various times in different storage components of the computing device 701, and are executed by the one or more processors 703 of the computer. An implementation of the analysis software 706 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It may be apparent to those skilled in the art that various modifications and variations may be made without departing from the scope or spirit. Other configurations may be apparent to those skilled in the art from consideration of the specification and practice described herein. It is intended that the specification and described configurations be considered as exemplary only, with a true scope and spirit being indicated by the following claims.

1. An apparatus comprising:
one or more processors; and
memory storing processor executable instructions that, when executed by the one or more processors, cause the apparatus to:
receive, from a sensing device, a signal, wherein the signal is indicative of a condition;
determine, based on the signal, whether the condition satisfies a threshold; and
generate, based on the condition satisfying the threshold, an alarm, wherein the alarm is associated with the condition.

2. The apparatus of claim 1, wherein the processor executable instructions, when executed by the one or more processors, further cause the apparatus to output, on a display device, the alarm.

3. The apparatus of claim 1, wherein the sensing device comprises an electrochemical sensor.

4. The apparatus of claim 1, wherein the sensing device comprises a corrosion coupon.

5. The apparatus of claim 1, wherein the signal is an electromagnetic signal.

6. The apparatus of claim 1, wherein the condition is a level of electrolytes disposed in a fluid.

7. The apparatus of claim 1, wherein the condition is corrosion.

8. The apparatus of claim 1, wherein the threshold comprises a value.

9. A method comprising:
receiving, from a sensing device, a signal, wherein the signal is indicative of a condition;
determining, based on the signal, whether the condition satisfies a threshold; and
generating, based on the condition satisfying the threshold, an alarm, wherein the alarm is associated with the condition.

10. The method of claim 9, further comprising, outputting on a display device, the alarm.

11. The method of claim 9, wherein the sensing device comprises an electrochemical sensor.

12. The method of claim 9, wherein the sensing device comprises a corrosion coupon.

13. The method of claim 9, wherein the signal is an electromagnetic signal.

14. The method of claim 9, wherein the condition is a level of electrolytes disposed in a fluid.

15. The method of claim 9, wherein the condition is corrosion.

16. The method of claim 9, wherein the threshold comprises a value.

17. A system comprising:
a sensing device configured to:
detect a condition; and
generate, based on the condition, a signal, wherein the signal is indicative of the condition;
a computing device configured to:
receive, from the sensing device, the signal;
determine, based on the signal, whether the condition satisfies a threshold; and
generate, based on the condition satisfying the threshold, an alarm signal, wherein the alarm is associated with the condition;
transmit the alarm signal; and
a user device configured to;
receive the alarm signal; and
output, based on the alarm signal, an alarm, wherein the alarm is indicative the condition.

18. The system of claim 17, wherein the user device comprises a display element and the user device is further configured to output, on the display element the alarm.

19. The system of claim 17, wherein the sensing device comprises an electrochemical sensor.

20. The system of claim 17, wherein the condition is a level of electrolytes disposed in a fluid.
